(19) United States
(12) Patent Application Publication
(10) Pub. No.: US 2014/0271755 A1
(43) Pub. Date: Sep. 18, 2014

(54) Antimicrobial Garment and Method of Manufacture

(71) Applicant: William C. Busch, North Kansas City, MO (US)

(72) Inventor: William C. Busch, North Kansas City, MO (US)

(21) Appl. No.: 13/834,920

(22) Filed: Mar. 15, 2013

(51) Int. Cl. A01N 25/34; A01N 59/16

(52) U.S. Cl. CPC A01N 25/34; A01N 59/16
USPC 424/404; 424/617; 2/69

(57) ABSTRACT

A garment treated with an antimicrobial agent that causes the garment to repel foreign objects when exposed to sunlight.

### BACKGROUND OF THE INVENTION

1. Field

This invention relates generally to wearable garments and, in particular, to a garment having antimicrobial properties and method of manufacture.

2. Discussion of Related Art

A garment worn by a user is typically laundered between uses via a washing machine or dry cleaning. A typical use period extends for one day. In some environments, however, the user may be exposed to a relatively higher concentration of germs or bacteria than normal environments, e.g., in a hospital environment.

In such an environment, it may be necessary for the user to launder the garment or change garments several times in one day to avoid further spread and/or cross contamination of the bacteria. Washing and/or changing the garment is undesirable because it results in downtime for the user. For hospital personnel, such downtime may be particularly inconvenient and, in some cases, life threatening to patients in the hospital who require immediate attention.

Thus, there is a demand for a garment capable of remaining bacteria free without requiring laundering.

### SUMMARY OF THE INVENTION

The following brief description is provided to indicate the nature of the subject matter disclosed herein. While certain aspects of the present inventive concept are described below, the summary is not intended to limit the scope of the present inventive concept.

The present inventive concept provides, in its simplest form, a wearable garment treated with an antimicrobial agent that causes the garment to kill foreign objects that contact the garment and repel foreign objects when the garment is exposed to sunlight.

The aforementioned may be achieved in one aspect of the present inventive concept by providing a wearable garment. The garment may include a front side and a back side (i) connected at uppermost regions, (ii) at least partially spaced from each other along side regions, and/or (iii) each having an interior surface and an exterior surface. At least one of the exterior surface and the interior surface may be treated with an antimicrobial agent.

The antimicrobial agent may be contained in a coating applied to surfaces of at least the front side and the back side of the garment. The antimicrobial agent may be titanium dioxide. The garment may be operable to repel foreign particles from the surfaces treated with the antimicrobial agent when exposed to sunlight.

The garment may further include side portions connecting the front side and the back side along the side regions thereof. The side portions and the front and back sides may have different properties such as different elasticity and/or permeability. The side portions may include a plurality of serrations therein. The side portions may be manufactured using a mesh material. The side portions may include a plurality of apertures therethrough.

The aforementioned may be achieved in another aspect of the present inventive concept by providing a method of manufacturing a garment. The method may include the steps of connecting a front side and a back side of the garment at uppermost regions, and/or treating at least one of the exterior surface and the interior surface with an antimicrobial agent. The front side and the back side may be at least partially spaced from each other along side regions. The front side and the back side may each have an interior surface and an exterior surface.

The antimicrobial agent may be contained in a coating on surfaces of at least the front side and the back side of the garment. The antimicrobial agent may be titanium dioxide. The garment may be operable to repel foreign particles from the surfaces treated with the antimicrobial agent when exposed to sunlight.

The method may further include the step of connecting the front side and the back side along the side regions thereof with side portions. The side portions and the front and back sides may be have one or more different properties such as different elasticity and/or permeability. The side portions may have a plurality of serrations therein. The side portions may be manufactured from a mesh material.

The side portions may have a plurality of apertures therethrough. The step of treating the at least one of the exterior surface and the interior surface with the antimicrobial agent may include spraying the at least one of the exterior surface and the interior surface with a fluid containing the antimicrobial agent. The step of treating the at least one of the exterior surface and the interior surface with the antimicrobial agent may include soaking the at least one of the exterior surface and the interior surface in a fluid containing the antimicrobial agent.

Additional aspects, advantages, and utilities of the present invention will be set forth in part in the description which follows and, in part, will be obvious from the description, or may be learned by practice of the present invention.

### BRIEF DESCRIPTION OF THE DRAWINGS

Embodiments of the present inventive concept are described in detail below with reference to the attached drawing figures, wherein:

FIG. 1 is a front view of an antimicrobial garment of the present inventive concept;

FIG. 2 is a right side view of the antimicrobial garment of the present inventive concept shown in FIG. 1;

FIG. 3 is a left side view of the antimicrobial garment of the present inventive concept shown in FIG. 1;

FIG. 4 is a rear right side perspective view of the antimicrobial garment of the present inventive concept shown in FIG. 1; and

FIG. 5 is a rear view of the antimicrobial garment of the present inventive concept shown in FIG. 1.

The drawing figures do not limit the present inventive concept to the specific embodiments disclosed and described herein. The drawings are not necessarily to scale, emphasis instead being placed upon clearly illustrating the principles of the present inventive concept.

### DETAILED DESCRIPTION OF THE INVENTION

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

Turning to FIGS. 1-5, an antimicrobial garment 10 is illustrated. The garment 10 includes a front side 12 having an exterior surface 14 and an interior surface 16, and a back side 20 having an exterior surface 22 and an interior surface 24. The front side 12 and the back side 20 are connected to each other at uppermost regions 30, 32 thereof via a seam 34.

The front side 12 and the back side 20 include side regions 40, 42 that are connected to each other in a spaced relationship via side portions 50. Each of the side portions extends along equal lengths of the side regions 40, 42 from an uppermost body seam 52 to a lowermost body seam 54. The front side 12 includes a pocket 56 formed by a second layer of material of the front side 12 secured to the front side 12.

Each of the front side 12 and the back side 20 include extremity regions 60 that project away from each other on either side thereof. The side regions 40, 42 include an extremity section 62 that extends along a bottommost portion 66 of each of the extremity portions 60 so as to space a portion of the front side 12 and the back side 20 from each other therealong, as best illustrated in FIG. 4. The extremity section 62 extends from the uppermost body seam 52 in a direction away from the lowermost body seam 54.

The side portions 50 have an equal width along an entirety of the garment 10. In the exemplary embodiment, the side portions 50 are made of a mesh material having a plurality of apertures 70 throughout an entirety of the side portions 50. The apertures 70 are in the form of serrations, and are configured to facilitate passage of air between an interior of the garment and an exterior of the garment 10. In this manner, a user of the garment 10 may be more comfortable while wearing the garment 10.

Each of the front side 12 and the back side 20 are made of a same material, in the exemplary embodiment. It is foreseen, however, that the front and back sides 12, 20 may be made of different materials without deviating from the scope of the present inventive concept. The material may be cotton, nylon, and/or a combination thereof. The front and back sides 12, 20 are solid, so generally have less permeability to air relative to the side portions 50 due to the apertures 70. The side portions 50 are made of a material that may be different than or the same as that of the front side 12 and the back side 20, and provides an increased degree of elasticity relative to the front and back sides 12, 20 due to the apertures 70. In this manner, the properties of the front and back sides 12, 20 relative to the side portions 50 are different.

In the exemplary embodiment, the garment 10 is manufactured by assembling the front and rear sides 12, 20 with the side portions 50 therebetween to form the seams 34, 52, 54. The garment 10 is then at least partially coated with an antimicrobial agent that is at least partially dissolved in a liquid so as to form a coating on at least the exterior surfaces 14, 22 of the front and rear sides 12, 20. In the exemplary embodiment, the antimicrobial agent in the liquid applied to at least the portion of the garment 10 via spraying the garment 10. In this manner, only the interior surfaces 16, 24 that do not include the antimicrobial agent are able to come into contact with skin of the user. It is foreseen that the antimicrobial agent in the liquid may be applied to the garment 10 via soaking of the garment 10, e.g., in a bath or the like, brushing, and/or the like.

The antimicrobial agent has a high refractive index with strong UV light absorbing capabilities. In the exemplary embodiment, the antimicrobial agent is titanium dioxide (TiO₂). It is foreseen that the antimicrobial agent in the liquid may be applied to limited portions of the garment 10 to minimize contact of the antimicrobial agent with the user, e.g., only on the back 20, the front 12 with or without the pocket 56, one or more of the side portions 50, or the pocket 56 without deviating from the scope of the present inventive concept.

Once the antimicrobial agent in the liquid is applied to the garment 10, the garment 10 is subjected to a curing process, e.g., an air dryer, a light, and/or a heater, to bond the antimicrobial agent to the garment 10. Once bonded, the garment 10 may be washed via a traditional clothing washer or the like without causing the antimicrobial agent to separate from the garment 10.

The antimicrobial agent is effective to kill any bacteria and/or germs that may come into contact with the garment 10. Further, when the garment 10 with the antimicrobial agent is exposed to sunlight, the garment 10 discharges or repels any foreign particles on the garment 10 and into the surrounding environment. In this manner, the garment 10 is effective to clean and/or rid itself of bacteria, germs and/or other undesired contaminates without using the traditional clothing washer.

Accordingly, the present inventive concept provides a solution to the aforementioned issues by providing a garment treated with an antimicrobial agent that causes the garment to repel foreign objects when exposed to sunlight.

Having now described the features, discoveries and principles of the general inventive concept, the manner in which the general inventive concept is constructed and used, the characteristics of the construction, and advantageous, new and useful results obtained; the new and useful structures, devices, tools, elements, arrangements, parts and combinations, are set forth in the appended claims.

It is also to be understood that the following claims are intended to cover all of the generic and specific features of the general inventive concept herein described, and all statements of the scope of the general inventive concept which, as a matter of language, might be said to fall therebetween.

1. A garment comprising:
a front side and a back side (i) connected at uppermost regions, (ii) at least partially spaced from each other along side regions, and (iii) each having an interior surface and an exterior surface,
wherein at least one of the exterior surface and the interior surface is treated with an antimicrobial agent.

2. The garment according to claim 1, wherein the antimicrobial agent is contained in a coating on surfaces of at least the front side and the back side of the garment.

3. The garment according to claim 1, wherein the antimicrobial agent is titanium dioxide.

4. The garment according to claim 1, wherein the garment is operable to repel foreign particles from the surfaces treated with the antimicrobial agent when exposed to sunlight.

5. The garment according to claim 1, further comprising:
side portions connecting the front side and the back side along the side regions thereof, the side portions and the front and back sides have from properties.

6. The garment according to claim 1, further comprising:
side portions connecting the front side and the back side along the side regions thereof, the side portions having a plurality of serrations therein.

7. The garment according to claim 1, further comprising:
side portions connecting the front side and the back side along the side regions thereof, the side portions being manufactured from a mesh material.

8. The garment according to claim 1, further comprising:
side portions connecting the front side and the back side along the side regions thereof, the side portions having a plurality of apertures therethrough.

9. A method of manufacturing a garment, the method comprising the steps of:
connecting a front side and a back side of the garment at uppermost regions, the front side and the back side (i) at least partially spaced from each other along side regions, and (ii) each having an interior surface and an exterior surface,
treating at least one of the exterior surface and the interior surface with an antimicrobial agent.

10. The method according to claim 9, wherein the antimicrobial agent is contained in a coating on surfaces of at least the front side and the back side of the garment.

11. The method according to claim 9, wherein the antimicrobial agent is titanium dioxide.

12. The method according to claim 9, wherein the garment is operable to repel foreign particles from the surfaces treated with the antimicrobial agent when exposed to sunlight.

13. The method according to claim 9, further comprising the step of:
connecting the front side and the back side along the side regions thereof with side portions, the side portions and the front and back sides have different properties.

14. The method according to claim 9, further comprising the step of:
connecting the front side and the back side along the side regions thereof with side portions, the side portions having a plurality of serrations therein.

15. The method according to claim 9, further comprising the step of:
connecting the front side and the back side along the side regions thereof with side portions, the side portions being manufactured from a mesh material.

16. The method according to claim 9, further comprising the step of:
connecting the front side and the back side along the side regions thereof with side portions, the side portions having a plurality of apertures therethrough.

17. The method according to claim 9, wherein the step of treating the at least one of the exterior surface and the interior surface with the antimicrobial agent includes spraying the at least one of the exterior surface and the interior surface with a fluid containing the antimicrobial agent.

18. The method according to claim 9, wherein the step of treating the at least one of the exterior surface and the interior surface with the antimicrobial agent includes soaking the at least one of the exterior surface and the interior surface in a fluid containing the antimicrobial agent.
